(19) United States
(12) Patent Application Publication
(10) Pub. No.: US 2026/0229902 A1
(43) Pub. Date: Aug. 6, 2026

(54) REGULATOR FOR A VEHICLE

(71) Applicant: BRP-ROTAX GMBH & CO. KG, Gunskirchen (AT)

(72) Inventors: Simon BERGMAIR, Wolfsegg am Hausruck (AT); Manfred MOESENEDER, Gunskirchen (AT); Radostin OGNYANOV, Wels (AT); Matthias WEINZIERL, Starnberg (DE); Ernst-Christian LAGEMANN, Rheine (DE)

(21) Appl. No.: 19/448,342

(22) Filed: Jan. 14, 2026

Related U.S. Application Data
(60) Provisional application No. 63/751,938, filed on Jan. 31, 2025.

(51) Int. Cl. H02J 7/24; B60R 16/023; B60R 16/03; H02M 1/088; H02M 3/158; H02M 7/145

(52) U.S. Cl. CPC H02J 7/243; B60R 16/0231; B60R 16/03; H02M 1/088; H02M 3/158; H02M 7/145; H02J 2207/20

(57) ABSTRACT

A regulator for a vehicle. The regulator includes an input stage configured to be operatively connected to the AC generator of the vehicle; an intermediate circuit electrically connected to the input stage; an output stage electrically connected to the intermediate circuit and configured to be connected to a battery of the vehicle; and a microcontroller communicatively connected to the input stage, the intermediate circuit, and the output stage. The input analog voltage controller assembly is configured and arranged to adjust the DC signal provided to the intermediate circuit to a voltage potential of approximately 60V. The microcontroller is configured to control the output stage to selectively vary the output voltage of the regulator, the output voltage being selectively variable between 0 V and 14.5 V.

### CROSS-REFERENCE

The present application claims priority to U.S. Provisional Patent Application No. 63/751,938, entitled “Regulator for a Vehicle,” filed Jan. 31, 2025, the entirety of which is incorporated by reference herein.

### FIELD OF TECHNOLOGY

The present disclosure describes a regulator for a vehicle.

### BACKGROUND

Personal vehicles, such as automobiles and motorcycles, require a battery to power a starter motor and/or accessories such as headlights and heaters. Cars often employ alternators to recharge the battery during operation. In many smaller vehicles, including motorcycles, a generator connected directly to the engine is often used. In some implementations of generators, movement of the engine is used to rotate a rotor about a fixed stator to generate current to recharge the battery.

In order to convert the alternating current (AC) electricity produced by the generator into direct current (DC) for charging the battery and to maintain the converted DC voltage within system parameters, vehicles generally include a regulator. Sometimes referred to as a rectifier-regulator, two types of regulators are commonly used.

Serial regulators operate as a switch in series with a rectifying assembly to open and close depending on the needs of the battery. When the switch is closed, power flows to the battery for charging thereof. When the battery is fully charged, the switch is opened to open the circuit and no power or current flows to the battery.

Shunt regulators include a plurality of switches in parallel with the battery. When the switches are open, power flows to the battery for charging thereof. When the switches are closed, current bypasses the battery and no power is supplied thereto.

Serial regulators generally have relatively good efficiency, but require rapid switching in order to provide a partial load. Shunt regulators have a more compact size than serial regulators and may provide partial loads more simply, but tend to have low efficiency and heating issues.

There is thus a desire for a regulator arrangement addressing at least some of these disadvantages.

### SUMMARY

It is an object of the present technology to ameliorate at least some of the inconveniences present in the prior art.

According to an aspect of the present technology, there is provided a regulator for a vehicle. The regulator includes an input stage configured to be operatively connected to an alternating current (AC) generator of the vehicle; an intermediate circuit electrically connected to the input stage; an output stage electrically connected to the intermediate circuit, the output stage being configured to be connected to a battery of the vehicle; and a microcontroller communicatively connected to the input stage, the intermediate circuit, and the output stage.

In some embodiments, the input stage is configured and arranged to convert an alternating current (AC) signal received from the stator to a direct current (DC) signal.

In some embodiments, the AC generator is a three-phase alternating current (AC) generator operatively connected to an engine of the vehicle; and the input stage is configured and arranged to convert a three-phase alternating current (AC) signal received from the AC generator to a direct current (DC) signal.

In some embodiments, the input stage is configured to be operatively connected to a stator of the AC generator.

In some embodiments, the input stage includes a plurality of thyristor and diode assemblies; a plurality of gate drivers operatively connected to the plurality of thyristor and diode assemblies; and the plurality of gate drivers is communicatively connected with the microcontroller.

In some embodiments, the intermediate circuit includes a capacitor assembly.

In some embodiments, the input stage includes an input analog voltage controller assembly.

In some embodiments, the input analog voltage controller assembly is configured and arranged to adjust the DC signal provided to the intermediate circuit to a voltage potential of approximately 60V.

In some embodiments, the output stage is configured and arranged to convert the 60V DC signal from the intermediate circuit to a 14V DC signal.

In some embodiments, the output stage comprises a plurality of parallel DC-DC stepdown converter assemblies.

In some embodiments, the output stage further includes an output analog voltage controller operatively connected to the plurality of parallel DC-DC stepdown converter assemblies.

In some embodiments, the input analog voltage controller is configured to selectively isolate the input stage, such that no energy from the AC generator charges the battery.

In some embodiments, the microcontroller is configured to set target values for an output voltage and to limit values of an output current of the output stage.

In some embodiments, the microcontroller is configured to control the output stage to selectively vary the output voltage of the regulator, the output voltage being selectively variable between 0 V and 14.5 V.

In some embodiments, during operation, the microcontroller is operatively connected to an engine control unit (ECU) of the vehicle; and the microcontroller is configured to selectively control operation of the input stage and the output stage based on at least one of: information received from the ECU, a temperature of the input stage, a temperature of the output stage, and an engine speed.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic illustration of a regulator according to a non-limiting embodiment of the present technology, as installed in a vehicle;

FIG. 2 is a detailed schematic of the regulator of FIG. 1;

FIG. 3 is a schematic illustration of the regulator of FIG. 1, with an input stage shown in detail;

FIG. 4 is a schematic illustration of the regulator of FIG. 1, with an intermediate circuit shown in detail;

FIG. 5 is a schematic illustration of the regulator of FIG. 1, with an output stage shown in detail;

FIG. 6 is a schematic illustration of a recuperation mode operation of the regulator of FIG. 100;

FIG. 7 is a schematic illustration of a standard operation of the regulator of FIG. 100;

FIG. 8 is a schematic illustration of a fast acceleration mode operation of the regulator of FIG. 100.

It is noted that the Figures may not be drawn to scale.

### DETAILED DESCRIPTION

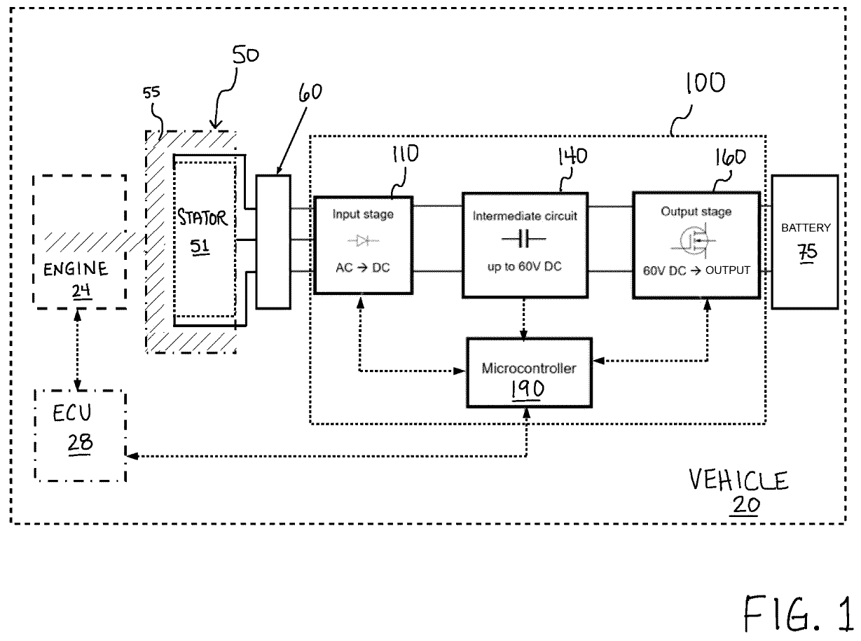

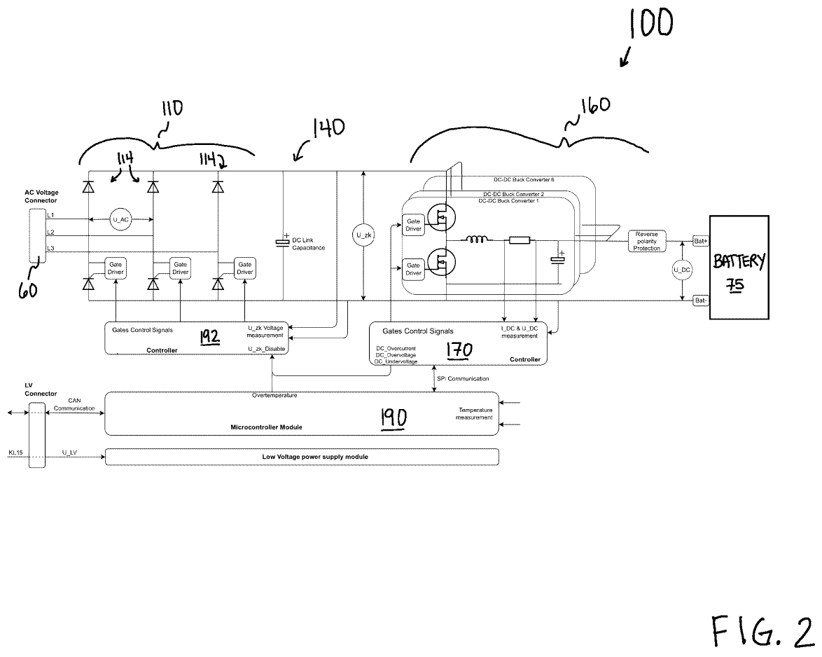

With reference to FIGS. 1 and 2, a rectifier-regulator 100, also referred to as a regulator 100, is schematically illustrated according to one non-limiting embodiment of the present technology. The regulator 100 is configured to be used in a vehicle 20, as shown in FIG. 1, having an alternating current (AC) generator 50 operatively connected to an engine 24 thereof. The particular type of vehicle 20 is not meant to be specifically limited, and could include, for example, a motorcycle.

When installed in the vehicle 20, the regulator 100 is connected between the AC generator 50 and a battery 75 of the vehicle 20. In the illustrated embodiment, an AC voltage connector 60 connects the regulator 100 to the generator 50, but the specific connection arrangement is not meant to be limited. The regulator 100 is arranged and configured to manage the flow of energy from the AC generator 50 to the battery 75 for charging thereof.

As is schematically illustrated in FIG. 1, the AC generator 50 includes a rotor 55 operatively connected to the engine 24 and a stator 51 disposed within the rotor 55. The rotor 55 is turned by rotation of the engine 24 and rotates about the stator 51, with the stator 51 rotationally fixed, such that an AC current is generated in wire windings (not shown) of the stator 51 during operation of the engine 24. In the present embodiment, the AC generator 50 is specifically a three-phase AC generator 50.

The regulator 100 includes an input stage 110 configured to be operatively connected to the AC generator 50, and more specifically to the stator 51 via the AC voltage connector 60. The regulator 100 includes an intermediate circuit 140 electrically connected to the input stage 110. The regulator 100 also includes an output stage 160 electrically connected to the intermediate circuit 140. The output stage 160 is configured to be connected to the battery 75 for delivering energy from the AC generator 50 to the battery 75 via the regulator 100.

In order to selectively control energy flow to the battery 75, the regulator 100 further includes a microcontroller 190 communicatively connected to the input stage 110, the intermediate circuit 140, and the output stage 160. The microcontroller 190 is configured to selectively adapt an output voltage of the regulator 100, and to selectively cause operation of the regulator 100 in one of at least three operating modes, explained in more detail below.

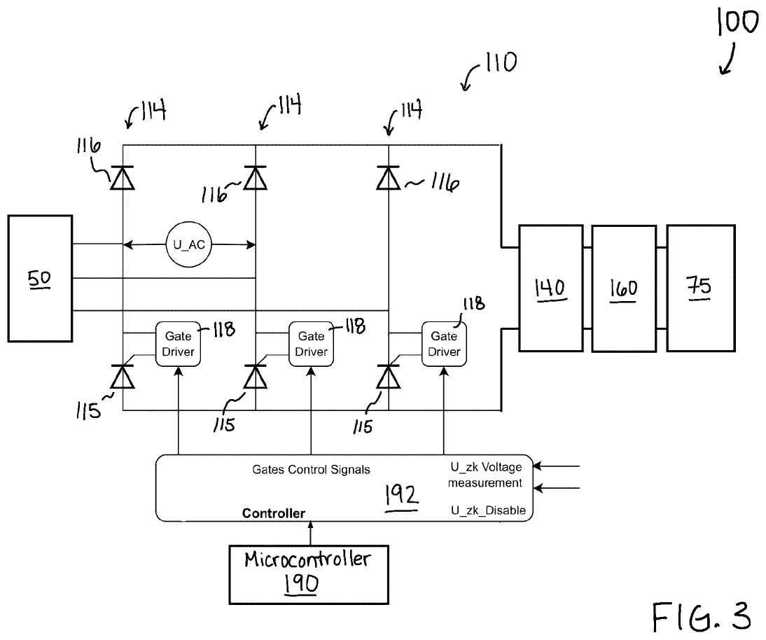

With additional reference to FIG. 3, the input stage 110 is configured and arranged to convert the AC signal received from the AC generator 50 to a direct current (DC) signal. Otherwise stated, the input stage 110 is a rectifying portion of the regulator 100. In the present arrangement, the input stage 110 is configured to be operatively connected to the stator 51, in order to convert a three-phase AC signal received from the AC generator 50 to a DC signal.

To rectify the received AC signal, the input stage 110 includes a plurality of thyristor and diode assemblies 114. Each assembly 114 includes a thyristor 115 and a diode 116 operatively connected to the thyristor 115. Three parallel assemblies 114 are provided to treat the three-phase signal from the AC generator 50.

The input stage 110 also includes a plurality of gate drivers 118 operatively connected to the assemblies 114. In the illustrated embodiment, one gate driver 118 is connected to each of the thyristor and diode assemblies 114. Specifically, each gate driver 118 is operatively connected to a corresponding one of the thyristors 115.

Each of the gate drivers 118 is communicatively connected with the microcontroller 190. As is illustrated in FIGS. 2 and 3, the gate drivers 118 are controlled by an analog voltage controller assembly 192. The controller assembly 192 receives voltage target values from the microcontroller 190 and in turn controls the gate drivers 118 to produce the DC signal received at the intermediate circuit 140. In the present embodiment, the controller assembly 192 is configured and arranged to adjust the DC signal provided to the intermediate circuit 140 to a voltage potential of approximately 60V.

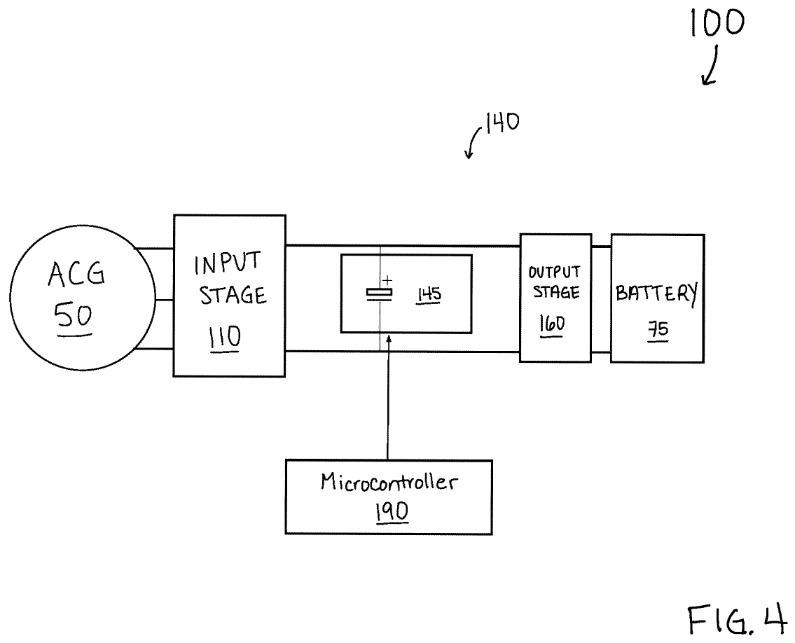

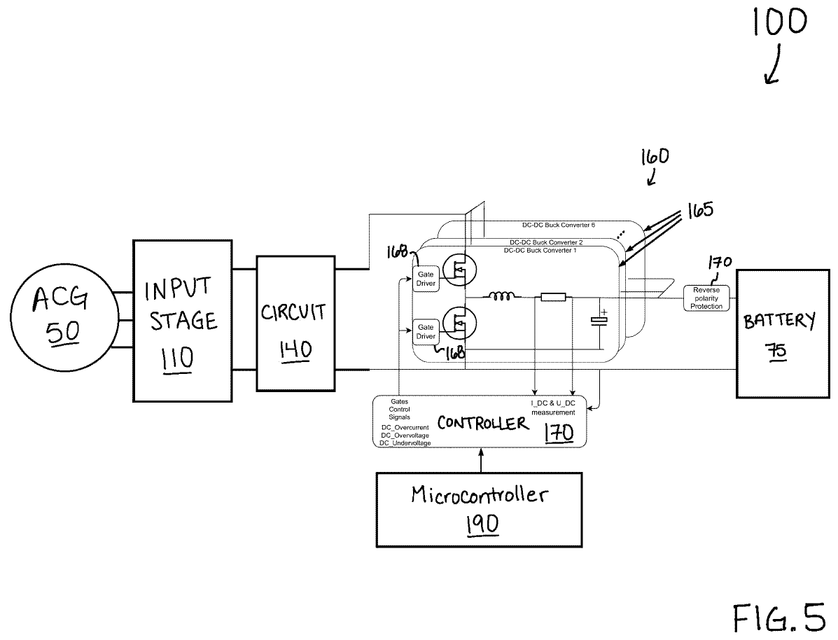

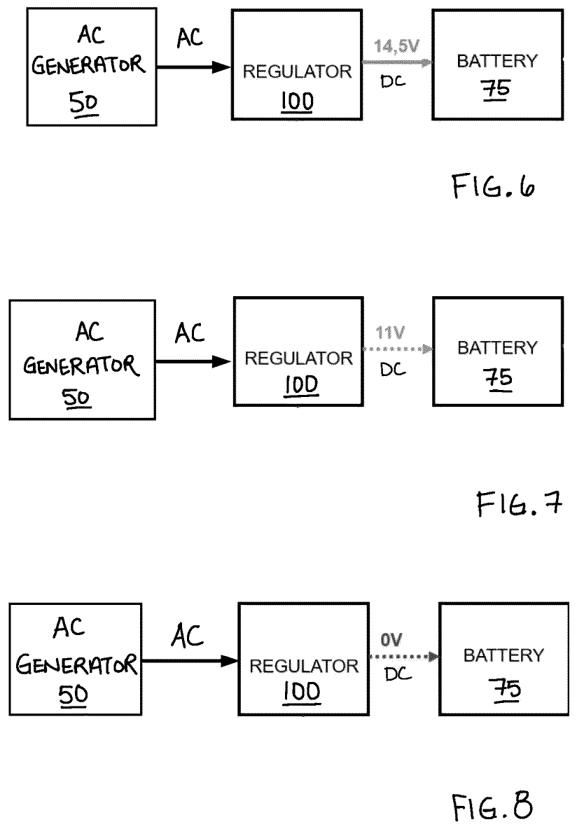

With additional reference to FIG. 4, the intermediate circuit 140 includes a capacitor assembly 145. The capacitor assembly 145 aids in smoothing the received rectified and approximately 60V DC signal. The capacitor assembly 145 is communicatively connected to the microcontroller 190, specifically for providing temperature information and voltage from the capacitor assembly 145 to the microcontroller 190, further providing ongoing monitoring of the voltage of the capacitor assembly 145.

With additional reference to FIG. 5, the output stage 160 is configured and arranged to convert the 60V DC signal received from the intermediate circuit 140 to an output DC signal voltage. The output stage 160 includes a plurality of parallel DC-DC stepdown converter assemblies 165. In the illustrated embodiment, there are specifically six parallel converter assemblies 165. It is contemplated that the exact number of assemblies 165 could vary in different embodiments. Each converter assembly 165 includes a pair of gate drivers 168 for selectively controlling the corresponding assembly 165.

The output stage 160 further includes an output analog voltage controller 170 operatively connected to the DC-DC stepdown converter assemblies 165. The controller 170 is configured to control the output voltage delivered to the battery 75 (when in use) via the gate drivers 168, based on target voltage and current values received by the controller 170 from the microcontroller 190.

When installed in the vehicle 20, the microcontroller 190 is operatively connected to an engine control unit (ECU) 28 of the vehicle 20. The microcontroller 190 is correspondingly configured to control the regulator 100 based on information received from the ECU 28. The microcontroller 190 is also configured to deliver information regarding the regulator 100 to the ECU 28, or other computational systems of the vehicle 20. In the present embodiment, the microcontroller 190 is configured to selectively control operation of the input stage 110 and the output stage 160 based on at least one of: information received from the ECU, a temperature of the input stage 110, a temperature of the output stage 160, and an engine speed. For instance, the microcontroller 190 can stop transfer of energy through the regulator 100 when either of the input and output stages 110, 160 has a temperature higher than an acceptable temperature limit.

The microcontroller 190 is further configured to set target values for an output voltage and to limit values of an output current of the output stage 160. The regulator 100 is thus configured to provide charging control to selectively change the energy transferred from the AC generator 50 to the battery 75., for example based on the state of charge (SOC) of the battery 75 or selected driving modes of the vehicle 20. With reference to FIGS. 6 to 8, three examples of operation of the regulator 100 are illustrated. The microcontroller 190 is configured to control the output stage 160 to selectively vary the output voltage of the regulator 100, the output voltage being selectively variable between 0 V and 14.5 V.

During operation of the regulator 100 as illustrated in FIG. 6, energy is transmitted from the generator 50 to the battery 75 during operation of the vehicle 20, where the battery 75 is being used and recharged simultaneously. The microcontroller 190 provides the target output voltage and current to the analog voltage controller 170, which in turn controls the DC-DC stepdown converter assemblies 165 to output approximately 14.5V.

In some cases, the regulator 100 could reduce the energy transfer to 11V to the battery 75, for example in response to the operator of the vehicle 20 or the ECU 28 of the vehicle 20 being set to a fuel saving operation. Illustrated in FIG. 7, the microcontroller 190 controls the output voltage controller 170 such that the regulator 100 provides about 11V to the battery 75. By providing 11V, the battery 75 receives some charge but will generally decrease in charge over time, but the decreased energy transfer will provide at least some fuel savings. In at least some cases, the microcontroller 19 could receive an indication that the charge of the battery 75 has fallen below a predetermined threshold or the health of the battery 75 is insufficient and subsequently the microcontroller 190 could return the voltage output to 14.5 V.

The regulator 100 is further configured to operate, illustrated in FIG. 8, where the regulator 100 selectively and temporarily outputs no energy, i.e. the output voltage is 0V. This permits all power to go to acceleration of the vehicle 20, while all electric power for the vehicle 20 comes from the battery 75.

In the case of preventing output voltage of the regulator 100, such as for the fast acceleration mode, the microcontroller 190 may also be configured to cause the input analog voltage controller 192 to selectively isolate the input stage 110, such that no energy from the AC generator 50 charges the battery 75. By isolating the input stage 110, energy can be prevented from being transferred through the regulator 100.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

What is claimed is:

1. A regulator for a vehicle, the regulator comprising:
an input stage configured to be operatively connected to an alternating current (AC) generator of the vehicle;
an intermediate circuit electrically connected to the input stage;
an output stage electrically connected to the intermediate circuit, the output stage being configured to be connected to a battery of the vehicle; and
a microcontroller communicatively connected to the input stage, the intermediate circuit, and the output stage.

2. The regulator of claim 1, wherein:
the AC generator is a three-phase alternating current (AC) generator operatively connected to an engine of the vehicle; and
the input stage is configured and arranged to convert a three-phase alternating current (AC) signal received from the AC generator to a direct current (DC) signal.

3. The regulator of claim 1, wherein the input stage is configured to be operatively connected to a stator of the AC generator.

4. The regulator of claim 3, wherein the input stage is configured and arranged to convert an alternating current (AC) signal received from the stator to a direct current (DC) signal.

5. The regulator of claim 1, wherein the input stage comprises:
a plurality of thyristor and diode assemblies;
a plurality of gate drivers operatively connected to the plurality of thyristor and diode assemblies; and
the plurality of gate drivers is communicatively connected with the microcontroller.

6. The regulator of claim 1, wherein the intermediate circuit comprises a capacitor assembly.

7. The regulator of claim 1, wherein the input stage comprises an input analog voltage controller assembly.

8. The regulator of claim 7, wherein the input analog voltage controller assembly is configured and arranged to adjust a direct current (DC) signal provided to the intermediate circuit to a voltage potential of approximately 60V.

9. The regulator of claim 1, wherein the output stage is configured and arranged to convert the 60V direct current (DC) signal from the intermediate circuit to a 14V DC signal.

10. The regulator of claim 9, wherein the output stage comprises a plurality of parallel DC-DC stepdown converter assemblies.

11. The regulator of claim 10, wherein the output stage further comprises an output analog voltage controller operatively connected to the plurality of parallel DC-DC stepdown converter assemblies.

12. The regulator of claim 7, wherein the input analog voltage controller is configured to selectively isolate the input stage, such that no energy from the AC generator charges the battery.

13. The regulator of claim 1, wherein the microcontroller is configured to set target values for an output voltage and to limit values of an output current of the output stage.

14. The regulator of claim 13, wherein the microcontroller is configured to control the output stage to selectively vary the output voltage of the regulator, the output voltage being selectively variable between 0 V and 14.5 V.

15. The regulator of claim 1, wherein:
during operation, the microcontroller is operatively connected to an engine control unit (ECU) of the vehicle; and
the microcontroller is configured to selectively control operation of the input stage and the output stage based on at least one of: information received from the ECU, a temperature of the input stage, a temperature of the output stage, and an engine speed.
